(19) United States
(12) Patent Application Publication
(10) Pub. No.: US 2014/0045561 A1
(43) Pub. Date: Feb. 13, 2014

(54) Cell Phone Protective Shield

(71) Applicant: Eric Liu, San Francisco, CA (US)

(72) Inventor: Eric Liu, San Francisco, CA (US)

(21) Appl. No.: 13/729,112

(22) Filed: Dec. 28, 2012

(30) Foreign Application Priority Data
Aug. 10, 2012 (TW) 101215416

(51) Int. Cl. H04M 1/02

(52) U.S. Cl. CPC H04M 1/0202
USPC 455/575.8

(57) ABSTRACT

A cell phone protective shield includes a shield body having a base panel, an opening cut through opposing front and back sides of the base panel and two opposite sidewalls respectively perpendicularly extended from two opposite lateral sides of the base panel, and a transparent thin-film member, electronic paper or thin-film display panel mounted in the base panel of the shield body over the opening.

### BACKGROUND OF THE INVENTION

1. Field of the Invention

The present invention relates to cell phone protective shields and more particularly, to such a cell phone protective shield, which has a transparent thin-film member, electronic paper or thin-film display panel mounted in an opening of the shield body thereof.

2. Description of the Related Art

Many cell phone protective shields are commercially available. These cell phone protective shields are adapted to hold a cell phone, protecting it against scratches and impact. A conventional cell phone protective shield is known comprising a shield body 7 (see FIG. 9) having a base panel 71 and upright peripheral walls 711;712;713 around the base panel 71. Another conventional cell phone protective shield is known comprising a back shell 80 and a front shell 8, wherein the front shell 81 comprises a front panel 81 and a peripheral walls 81;812;813 extending around the front panel 81, and a window 814 located at the front panel 81 corresponding to the display screen of the accommodated cell phone. FIG. 11 illustrates still another conventional design of cell phone protective shield, which comprises a back shell 90, a front shell 91, and a soft wrap 92. These conventional designs of cell phone protective shields simply designed to protect a cell phone without any added function.

### SUMMARY OF THE INVENTION

The present invention has been accomplished under the circumstances in view. It is the main object of the present invention to provide a cell phone protective shield, which is practical for protecting a cell phone and can provide an ornamental effect, an interesting effect, and a business card or memo displaying effect.

To achieve this and other objects of the present invention, a cell phone protective shield comprises a shield body having an opening cut through opposing front and back sides of a base panel thereof, and a transparent thin-film member, electronic paper or thin-film display panel mounted in the opening of the shield body. Thus, a user can set an ornamental sheet member that carries a design, a picture, a business card, a memo or any other thin sheet member in the shield body between the transparent thin-film member, electronic paper or thin-film display panel and the accommodated cell phone, enabling the cell phone protective shield to provide an ornamental effect, an interesting effect, or a business card or memo displaying effect.

Further, the cell phone protective shield can be configured having an electronic paper or thin-film display panel mounted in the opening of the shield body thereof that can be electrically connected to the accommodated cell phone for displaying static text and images.

Further, the opening of the shield body can be so configured to hold the transparent thin-film member, electronic paper or thin-film display panel in flush with the back side of the base panel of the shield body.

### BRIEF DESCRIPTION OF THE DRAWING

FIG. 1 is an exploded view of a cell phone protective shield in accordance with the present invention.

FIG. 2 is an elevational assembly view of the cell phone protective shield in accordance with the present invention.

FIG. 3 is schematic exploded view illustrating an application example of the cell phone protective shield in accordance with the present invention.

FIG. 4 is a cross sectional view, in an enlarged scale, of a part of the cell phone protective shield in accordance with the present invention.

FIG. 5 is an oblique rear elevation, illustrating a cell phone set in the shield body of the cell phone protective shield.

FIG. 6 is an oblique front elevational view of FIG. 5.

FIG. 7 is an exploded view of an alternate form of the cell phone protective shield in accordance with the present invention.

FIG. 8 is an exploded view of another alternate form of the cell phone protective shield in accordance with the present invention.

### DETAILED DESCRIPTION OF THE INVENTION

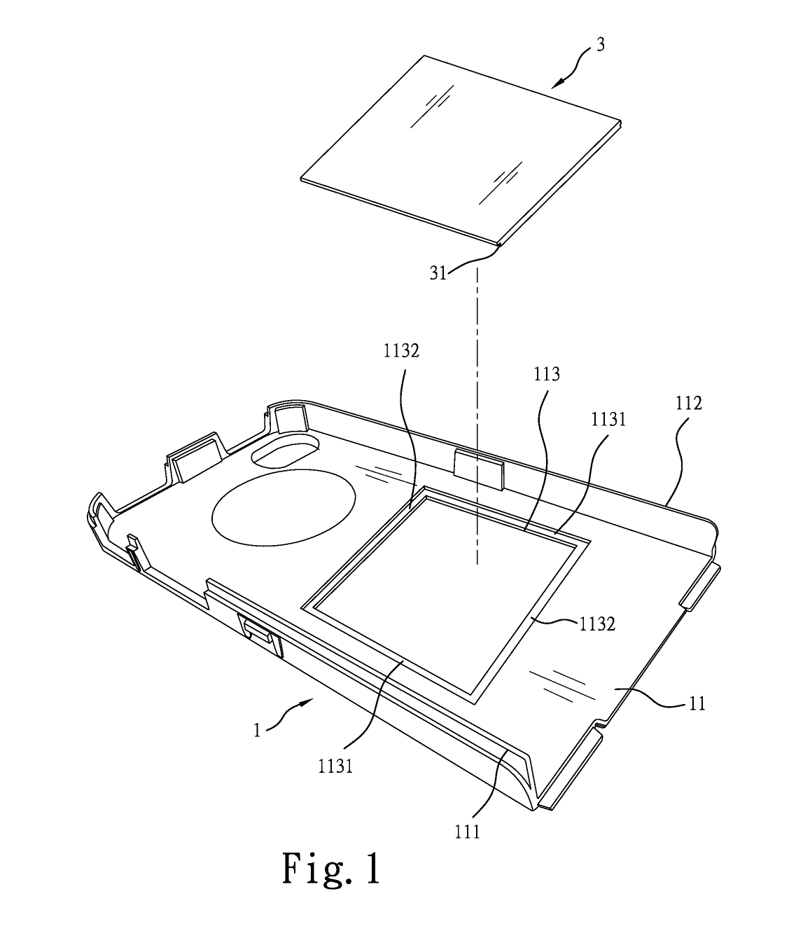

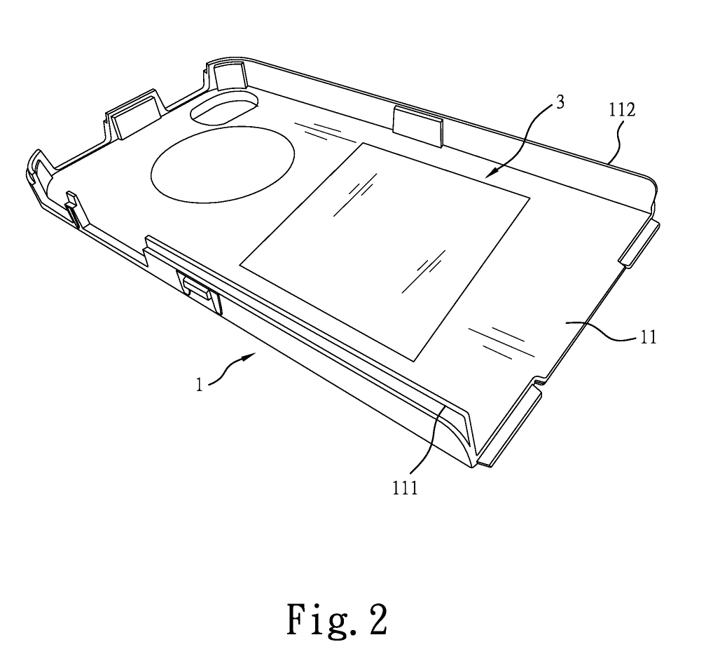

Referring to FIGS. 1 and 2, a cell phone protective shield in accordance with the present invention is shown. The cell phone protective shield comprises a shield body 1, which comprises a base panel 11 and two opposite sidewalls 111;12 respectively perpendicularly extended from two opposite lateral sides of the base panel 11. The shield body 1 is configured to accommodate a cell phone 2.

The main features of the present invention are outlined hereinafter:

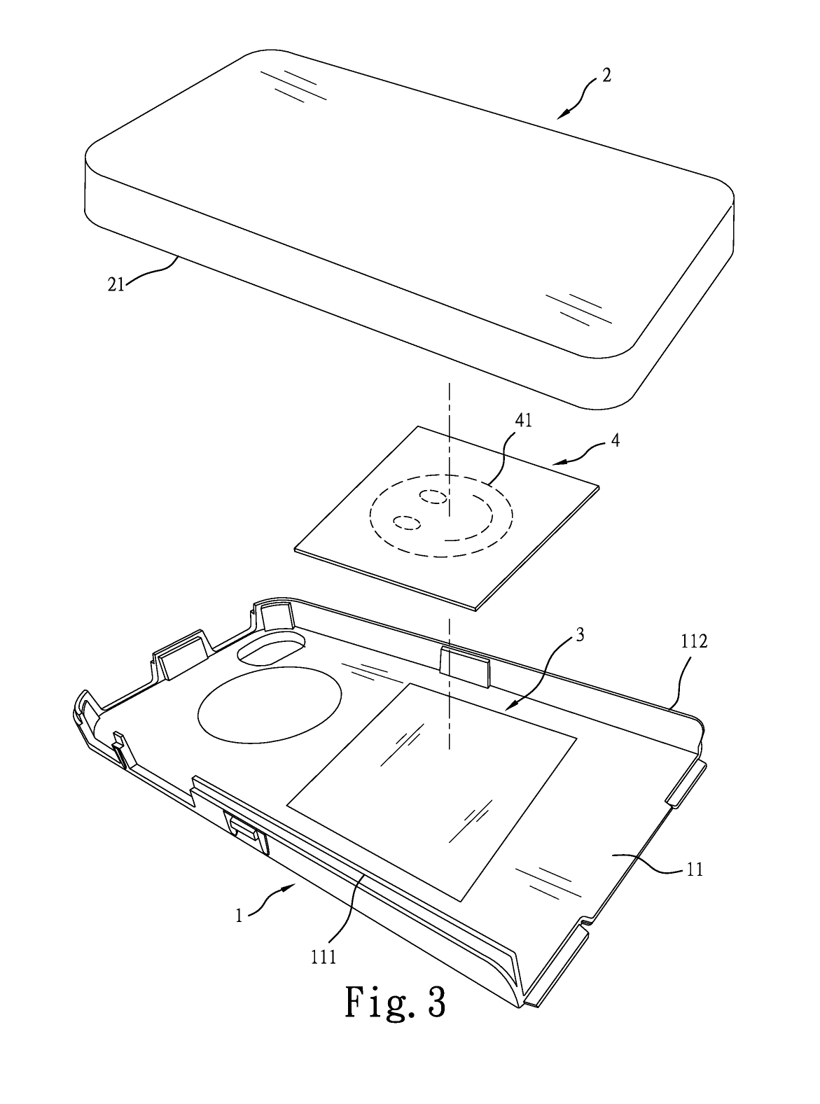

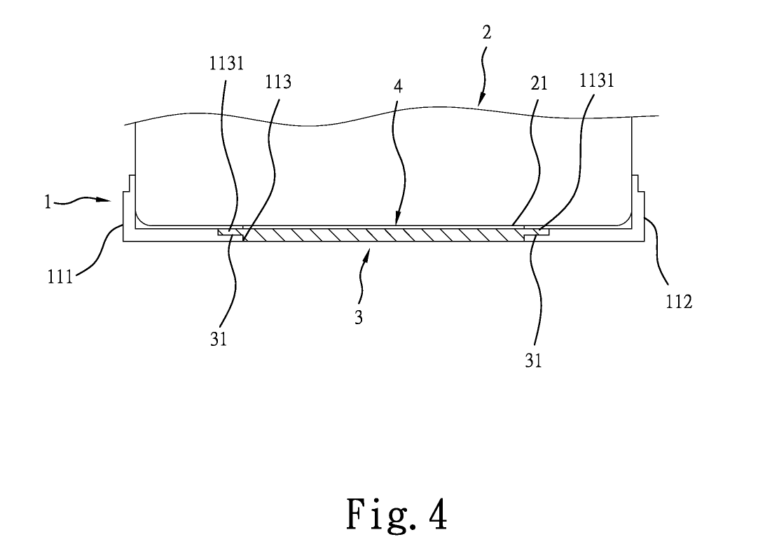

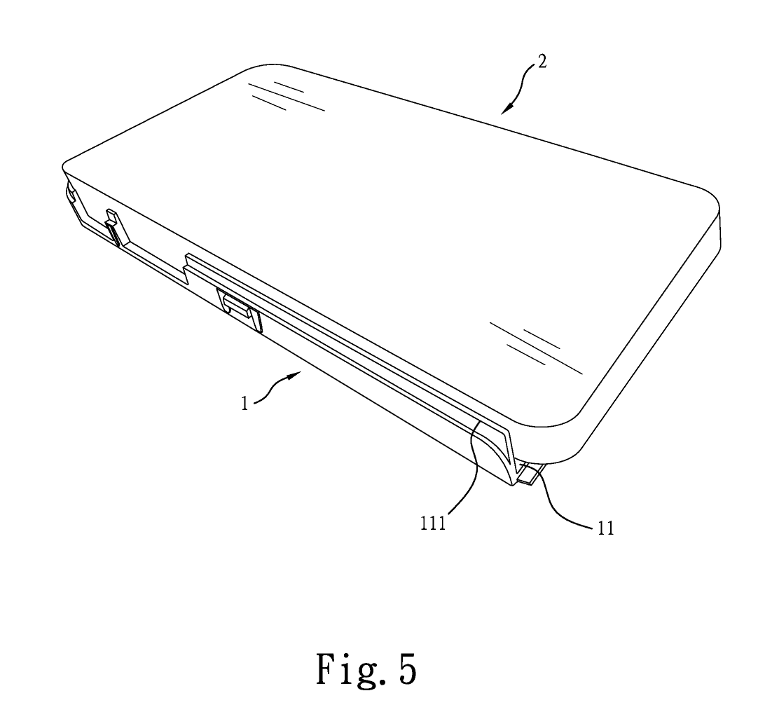

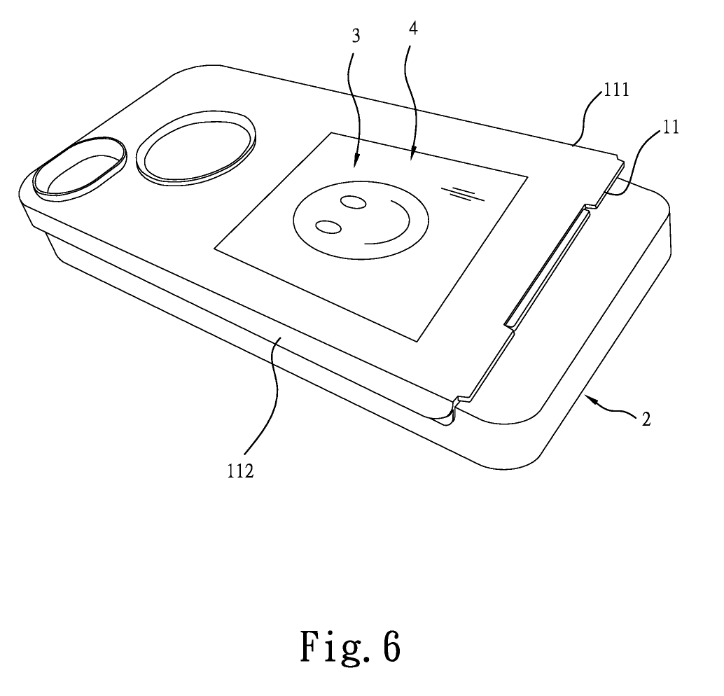

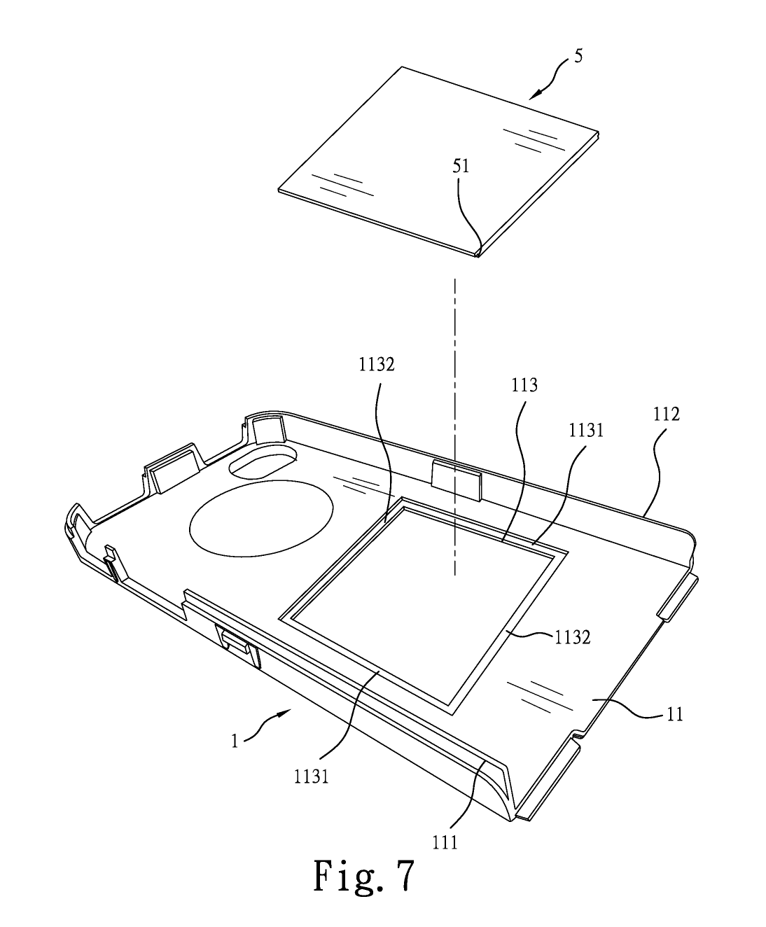

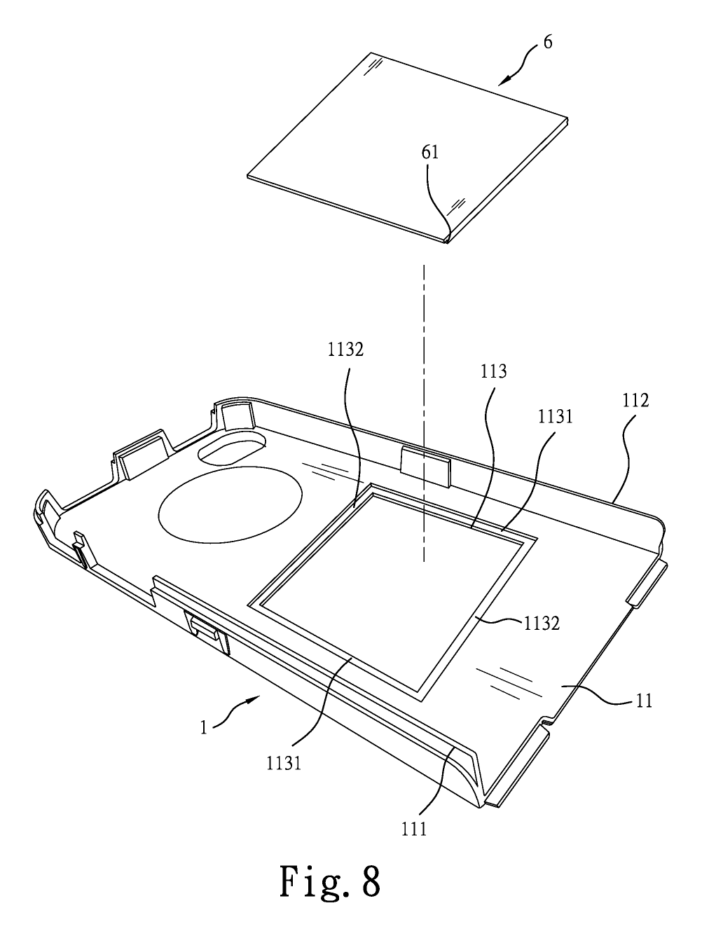

The shield body 1 comprises an opening 113 cut through opposing front and back sides of the base panel 11. Further, a transparent thin-film member 3 (see FIGS. 3-6), electronic paper 5 (see FIG. 7) or thin-film display panel 6 is mounted in the opening 113 of the shield body 1. A user can set an ornamental sheet member 4 that carries a design 41, a picture (not shown), a business card (not shown), a memo (not shown) or any other thin sheet member in the shield body 1 between the transparent thin-film member 3, electronic paper 5 or thin-film display panel 6 and the base panel 21 of the accommodated cell phone 2 (see FIGS. 4 and 6). Through the transparent film 3, the user or any other person can see the design 41 of the ornamental sheet member 4, the front side of the picture, or the writing of the business card, memo or any other thin sheet member that is set between the transparent thin-film member 3, electronic paper 5 or thin-film display panel 6 and the accommodated cell phone 2 (see FIG. 6). Further, the electronic paper 5 (see FIG. 7) or thin-film display panel 6 (see FIG. 8) can be electrically connected to the accommodated cell phone 2 for displaying static text and images.

The shield body 1 comprises recessed bearing portions 1131;1132 located at the back side of the base panel 11 around the opening 113. The transparent thin-film member 3, the electronic paper 5 and the thin-film display panel 6 each have a positioning flange 31 (see FIG. 3), 51 (see FIG. 7) or 61 (see FIG. 8) extended from the periphery in flush with a back side thereof. By means of the positioning flange 31, 51 or 61, the transparent thin-film member 3, electronic paper 5 or thin-film display panel 6 can be set in the recessed bearing portions 1131;1132 of the shield body 1 over the opening 113.

Further, the transparent thin-film member 3 can be a transparent PVC film, a transparent acrylic film, a transparent glass film, or a thin sheet member of any other transparent material.

According to the embodiment shown in FIGS. 1 and 2, the cell phone protective shield comprises a shield body 1 comprising a base panel 11, an opening 113 cut through opposing front and back sides of the base panel 11 and two opposite sidewalls 111;12 respectively perpendicularly extended from two opposite lateral sides of the base panel 11, and a transparent thin-film member 3 mounted in the base panel 11 of the shield body 1 over the opening 113. According to the embodiment shown in FIG. 7, the cell phone protective shield comprises a shield body 1 comprising a base panel 11, an opening 113 cut through opposing front and back sides of the base panel 11 and two opposite sidewalls 111;12 respectively perpendicularly extended from two opposite lateral sides of the base panel 11, and an electronic paper 5 mounted in the base panel 11 of the shield body 1 over the opening 113.

According to the embodiment shown in FIG. 8, the cell phone protective shield comprises a shield body 1 comprising a base panel 11, an opening 113 cut through opposing front and back sides of the base panel 11 and two opposite sidewalls 111;12 respectively perpendicularly extended from two opposite lateral sides of the base panel 11, and a thin-film display panel 6 mounted in the base panel 11 of the shield body 1 over the opening 113.

In conclusion, the invention provides a cell phone protective shield, which has the advantages and features as follows:

1. The shield body 1 has an opening 113 cut through opposing front and back sides of the base panel 11 thereof and a transparent thin-film member 3, electronic paper 5 or thin-film display panel 6 mounted in the opening 113. Thus, a user can set an ornamental sheet member 4 that carries a design 41, a picture, a business card, a memo or any other thin sheet member in the shield body 1 between the transparent thin-film member 3, electronic paper 5 or thin-film display panel 6 and the accommodated cell phone 2, enabling the cell phone protective shield to provide an ornamental effect, an interesting effect, or a business card or memo displaying effect.

2. The cell phone protective shield can be configured having an electronic paper 5 or thin-film display panel 6 mounted in the opening 113 of the shield body 1 that can be electrically connected to the accommodated cell phone 2 for displaying static text and images.

3. The opening 113 of the shield body 1 can be so configured to hold the transparent thin-film member 3, electronic paper 5 or thin-film display panel 6 in flush with the back side of the base panel 11 of the shield body 1.

What is claimed is:

1. A cell phone protective shield, comprising:
a shield body comprising a base panel, an opening cut through opposing front and back sides of said base panel and two opposite sidewalls respectively perpendicularly extended from two opposite lateral sides of said base panel; and
a transparent thin-film member mounted in said base panel of said shield body over said opening.

2. The cell phone protective shield as claimed in claim 1, wherein said transparent thin-film member is selected from the group of transparent PVC film, transparent acrylic film, transparent glass film.

3. The cell phone protective shield as claimed in claim 1, wherein said transparent thin-film member is selected from the group of electronic paper and thin-film display panel.

4. The cell phone protective shield as claimed in claim 1, wherein said shield body further comprises at least one recessed bearing portion located at the back side of said base panel around said opening.
